(19) United States
(12) Patent Application Publication
(10) Pub. No.: US 2025/0290354 A1
(43) Pub. Date: Sep. 18, 2025

(54) LATCH DEVICE FOR FRONT HOOD

(71) Applicant: Mitsui Kinzoku Act Corporation, Yokohama-shi (JP)

(72) Inventors: Minetaka KATAGAWA, Kanagawa (JP); Kosuke ANDO, Kanagawa (JP)

(73) Assignee: Mitsui Kinzoku Act Corporation, Yokohama-shi (JP)

(21) Appl. No.: 19/076,931

(22) Filed: Mar. 11, 2025

(30) Foreign Application Priority Data
Mar. 13, 2024 (JP) 2024-039324

(51) Int. Cl. E05B 81/16; B60R 5/02; E05B 81/06; E05B 81/34; E05B 81/56; E05B 83/24; E05B 83/26

(52) U.S. Cl. CPC E05B 81/16; B60R 5/02; E05B 81/06; E05B 81/34; E05B 81/56; E05B 83/24; E05B 83/26

(57) ABSTRACT

A latch device for a front hood of a vehicle including: a latch; a primary pawl; a secondary pawl; a motor configured to rotate forward and backward; and a release mechanism configured to operate by the motor, in which the release mechanism is configured to release a meshing state between the latch and the primary pawl by rotation of the motor in a first direction to move the front hood from the fully closed position to the half-engaged position, and release the meshing state between the latch and the primary pawl and the meshing state between the latch and the secondary pawl by rotation of the motor in a second direction opposite to the first direction to allow the front hood to move from the fully closed position to a fully open position.

### CROSS REFERENCE TO RELATED APPLICATIONS

This application claims priority to Japanese Patent Application No. 2024-039324 filed on Mar. 13, 2024, the content of which is incorporated herein by reference.

### TECHNICAL FIELD

The present disclosure relates to a latch device for a front hood.

### BACKGROUND ART

This section provides background information related to latch devices and is not necessarily prior art to the latch device of the present disclosure. In some vehicles such as an electric automatic vehicle and a rear engine automatic vehicle in which an engine is mounted behind a vehicle body, a front of the vehicle body is used as a front trunk (also referred to as a frunk). A front hood that opens and closes the frunk is appropriately locked by a latch device.

The latch device may be provided with an actuator configured to electrically open and close the front hood. For example, a latch device described in DE102018214355A includes a latch that engages with a striker, a lock mechanism that meshes with the latch and locks a hood in a fully closed state, a hook that holds the hood in a half-engaged state between the fully closed state and a fully open state, and an actuator that causes the lock mechanism and the hook to operate. When the actuator rotates in a first direction while the hood is in the fully closed state, the meshing between the lock mechanism and the latch is released, and the hood enters the half-engaged state. When the actuator rotates in a second direction opposite to the first direction from the half-engaged state of the hood, the hook rotates to allow the hood to enter the fully open state.

In the latch device of DE102018214355A, when the hood is opened from the fully closed state, the hood goes through the half-engaged state, and thus the hood is prevented from unintentionally entering the fully open state during traveling, for example, and safety is ensured.

### SUMMARY OF INVENTION

According to an aspect of the present disclosure, there is provided a latch device for a front hood of a vehicle, the latch device being provided to be engageable with a striker provided at the front hood and performing opening and closing control of the front hood, the latch device including:
a latch configured to engage with the striker when the front hood is in a closed state, the latch being biased by a biasing member in a direction to disengage from the striker;
a primary pawl configured to mesh with the latch when the latch engaging with the striker is disposed at a predetermined primary latch position to maintain the front hood at a fully closed position;
a secondary pawl configured to mesh with the latch when the latch released from a meshing state with the primary pawl is disposed at a predetermined secondary latch position to maintain the front hood at a half-engaged position;
a motor configured to rotate forward and backward; and
a release mechanism configured to operate by drive of the motor and release the meshing state between the latch and the primary pawl and a meshing state between the latch and the secondary pawl, in which
the release mechanism is configured to
release the meshing state between the latch and the primary pawl by rotation of the motor in a first direction to move the front hood from the fully closed position to the half-engaged position, and
release the meshing state between the latch and the primary pawl and the meshing state between the latch and the secondary pawl by rotation of the motor in a second direction opposite to the first direction to allow the front hood to move from the fully closed position to a fully open position.

### BRIEF DESCRIPTION OF DRAWINGS

FIG. 1 is a side view of a vehicle to which a latch device 1 for a front hood according to an embodiment of the present disclosure is applied, in a state where the front hood is in a fully open position.

FIG. 2 is a perspective view of the latch device 1 as viewed from a base plate 11 side.

FIG. 3 is an exploded perspective view of a housing member 10.

FIG. 4 is a diagram showing an internal configuration of the latch device 1.

FIG. 5 is a partial perspective view of the internal configuration of the latch device 1.

FIG. 6 is a diagram showing an actuator unit 40 accommodated in an actuator housing 40H.

FIG. 7 is diagram showing an operation of the latch device 1 when an electric motor 41 is rotated in a second direction from a state where a front hood FP is at a fully closed position.

FIG. 8 is diagram showing an operation of the latch device 1 when the electric motor 41 is rotated in a first direction from a state where the front hood FP is at the fully closed position.

FIG. 9 is a block diagram showing a control system of the latch device 1.

FIG. 10 is a flow of an open operation of the front hood FP when the vehicle is in a first state (stopped state or the like).

FIG. 11 is a flow of an open operation of the front hood FP when the vehicle is in a second state (traveling state or the like).

FIG. 12 is a flow of an open operation of the front hood FP by an in-frunk handle 31.

### DESCRIPTION OF EMBODIMENTS

Hereinafter, a latch device for a front hood according to an embodiment of the present disclosure will be described in detail with reference to the drawings. In the following description, a front side of a vehicle is denoted by Fr, a rear side thereof is denoted by Rr, a right side thereof is denoted by R, a left side thereof is denoted by L, an upper side thereof is denoted by U, and a lower side thereof is denoted by D in the drawings.

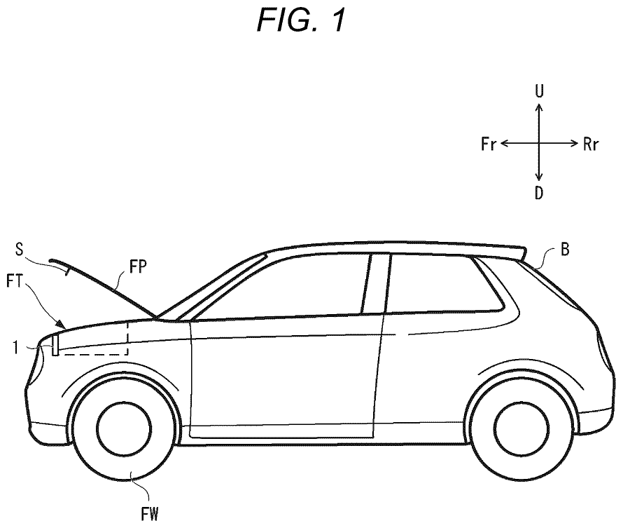

As shown in FIG. 1, a latch device 1 for a front hood (also simply referred to as a latch device 1) is applied to a four-wheel automatic vehicle such as an electric automatic vehicle including a front trunk (hereinafter, referred to as a frunk FT) between left and right front wheels FW in front of a vehicle body B, and performs opening and closing control of a front hood FP that opens and closes an upper opening of the frunk FT. In the example shown in FIG. 1, the front hood FP is at a fully open position. In the present embodiment, a striker S is provided at a lower portion of a front edge of the front hood FP. The latch device 1 performs control such that the front hood FP is maintained in a closed state or the frunk FT is opened with respect to the vehicle body B by switching between a state of engaging with the striker S and a state of releasing the engagement. Hereinafter, a specific configuration of the latch device 1 will be described in detail. In the following description, for the sake of convenience, each direction is specified in a posture of being mounted on the vehicle body B.

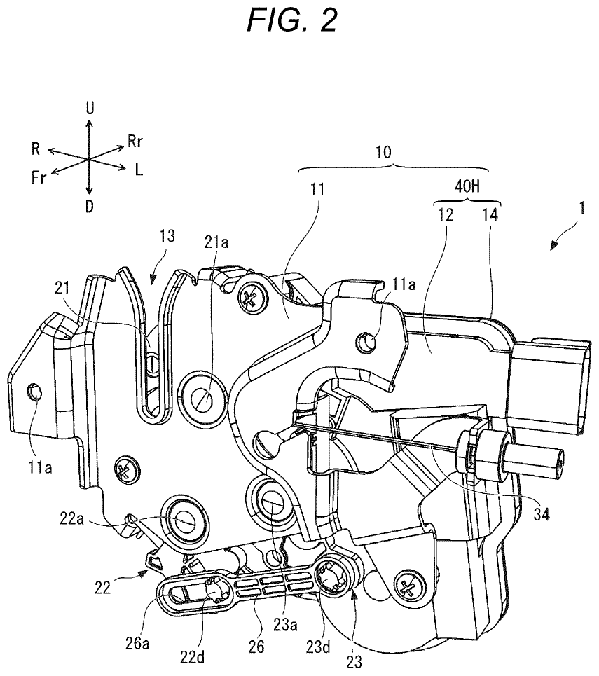

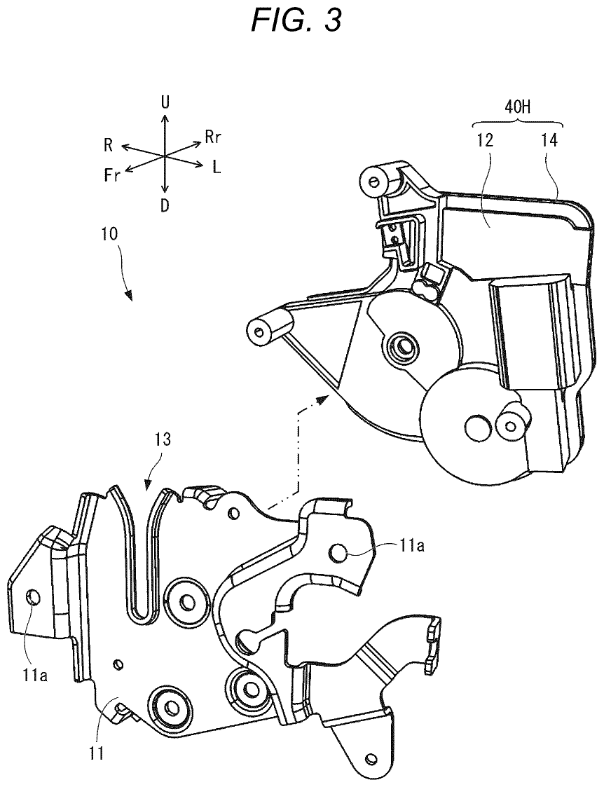

As shown in FIGS. 2 to 6, the latch device 1 includes a housing member 10, a latch 21, a primary pawl 22, a secondary pawl 23, an open lever 35, and an actuator unit 40. The housing member 10 includes a base plate 11, a case 12, and a cover 14. The case 12 accommodates the actuator unit 40 and is covered with the cover 14 from the rear side. The case 12 and the cover 14 form an actuator housing 40H that accommodates the actuator unit 40. The base plate 11 has a plate shape formed of steel. The base plate 11 is provided to face the case 12 and is fixed to the case 12. The latch 21, the primary pawl 22, the secondary pawl 23, and the open lever 35 are disposed between the base plate 11 and the case 12. In the base plate 11, a striker entrance groove 13 is formed on one side of an upper portion. The striker entrance groove 13 is a notch into which the striker S enters when the front hood FP is closed with respect to the frunk FT, and is formed to extend along an up-down direction and open at an upper edge of the base plate 11. A dimension of the striker entrance groove 13 is formed to a length that allows the front hood FP to be disposed at a fully closed position with respect to the frunk FT.

When the latch device 1 is attached to the vehicle body B, the base plate 11 is disposed on the front side of the vehicle, and the actuator housing 40H is disposed on the rear side of the vehicle. The base plate 11 is provided with a plurality of vehicle body attachment portions 11a, and is attached to the vehicle body B via fastening members such as bolts. Since the base plate 11 is disposed on the front side of the vehicle, an ease of assembly and an ease of attachment to the vehicle body B of a frunk cable 32 and an emergency cable 34 described later are improved. When a load collides with the latch device 1 when being loaded into the frunk FT, since the load collides with the base plate 11 first, the actuator unit 40 accommodated in the actuator housing 40H is protected. The latch device 1 thus attached to the vehicle body B can stably operate for a long time.

The latch 21, the primary pawl 22, and the secondary pawl 23 are supported by the base plate 11 via respective support shafts, and can rotate about axes parallel to each other. In the shown example, a latch shaft 21a which is a support shaft of the latch 21 is provided on a side of the striker entrance groove 13. A primary shaft 22a which is a support shaft of the primary pawl 22, and a secondary shaft 23a which is a support shaft of the secondary pawl 23 are provided below the latch shaft 21a around the latch 21.

The latch 21 engages with the striker S, and has a striker abutting portion 21b and a hook portion 21c at an outer peripheral portion thereof. The striker abutting portion 21b and the hook portion 21c extend from the latch shaft 21a in a radial direction, can be arranged to cross the striker entrance groove 13 of the base plate 11, and adjacent to each other with an accommodation groove 21d capable of accommodating the striker S therebetween.

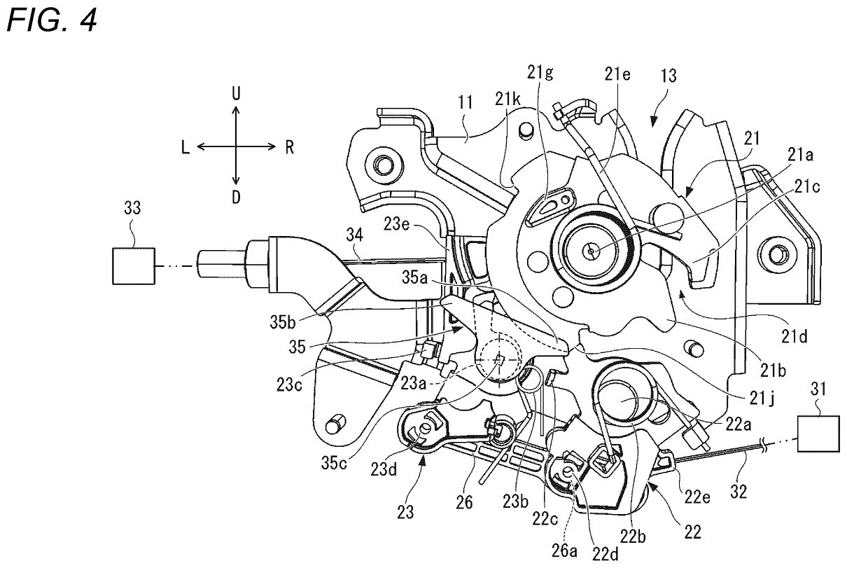

A latch spring 21e, which is a torsion coil spring, is provided between the latch 21 and the base plate 11. The latch 21 is biased in a direction (counterclockwise direction in FIG. 4. Hereinafter, this direction is also referred to as a release direction) to constantly disengage from the striker S to return to a predetermined engaging standby position by a biasing force of the latch spring 21e. The engaging standby position refers to a state where the hook portion 21c is retracted laterally with respect to the striker entrance groove 13, the striker abutting portion 21b is disposed at a position crossing the striker entrance groove 13, and an opening of the accommodation groove 21d is aligned with the striker entrance groove 13.

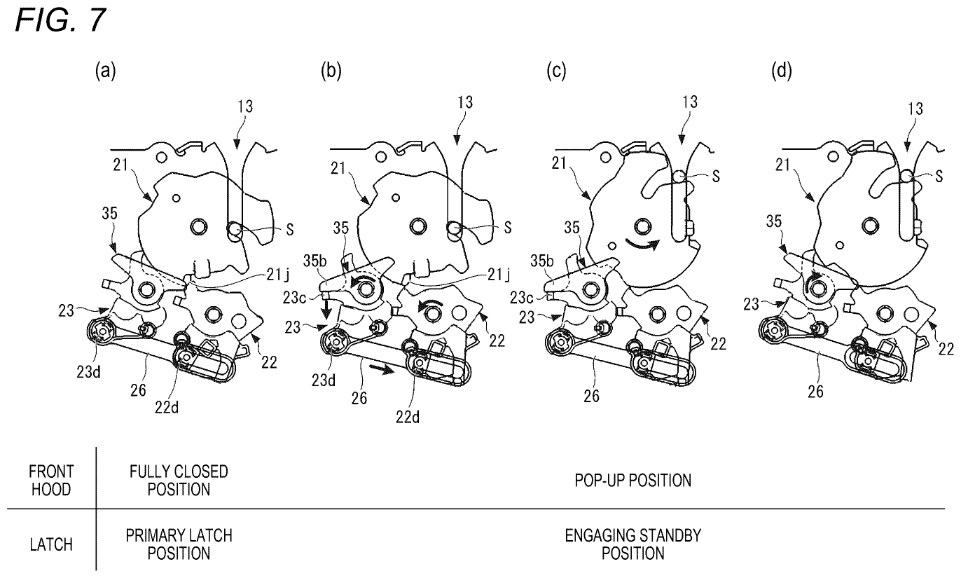

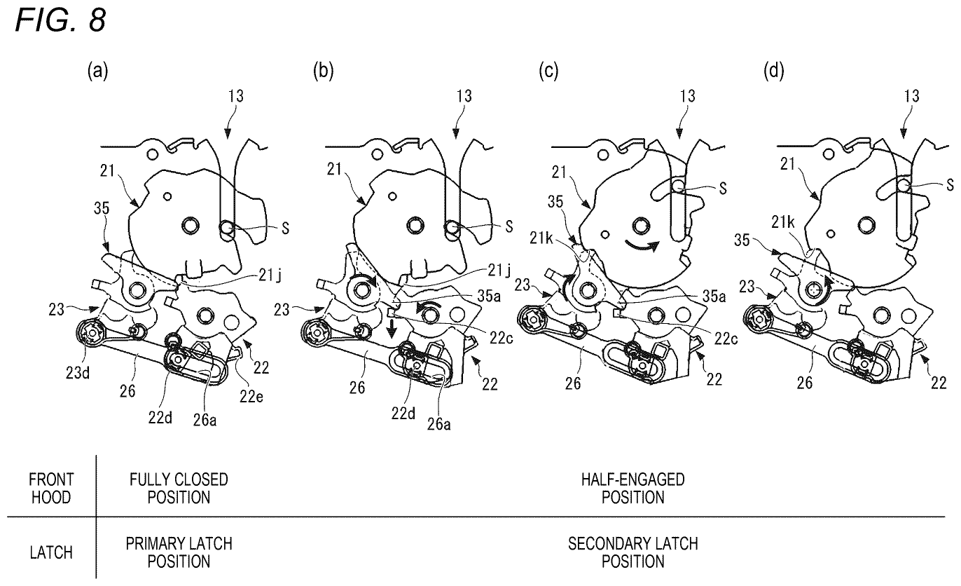

In the engaging standby position of the latch 21, when the front hood FP is closed, the striker S can enter the striker entrance groove 13. When the front hood FP moves in a closing direction from the fully open position (see FIG. 1), the striker S entering the striker entrance groove 13 abuts against the striker abutting portion 21b, and the front hood FP is disposed at a pop-up position (see (c) and (d) of FIG. 7). When the front hood FP is further moved in the closing direction from the pop-up position, the latch 21 is rotated in a direction (clockwise direction in FIG. 4) to engage with the striker S against the biasing force of the latch spring 21e, and the hook portion 21c is arranged across an opening end portion side of the striker entrance groove 13 while the striker S is accommodated in the accommodation groove 21d. Although details will be described later, a position where the accommodation groove 21d of the latch 21 is disposed at a lower portion of the striker entrance groove 13 is also referred to as a primary latch position of the latch 21 (see (a) of FIG. 7). In this case, the front hood FP is at the fully closed position. A position where the accommodation groove 21d of the latch 21 is positioned above the striker entrance groove 13 and the hook portion 21c is disposed across the striker entrance groove 13 is also referred to as a secondary latch position of the latch 21 (see (c) and (d) of FIG. 8). In this case, the front hood FP is in a half-engaged position.

The latch 21 is provided with a switch pressing portion 21g that can press a latch detection switch 51. The latch detection switch 51 is a switch that detects a rotation position of the latch 21. The switch pressing portion 21g protrudes from a surface of the latch 21 on an actuator unit 40 side. When the latch 21 is at the primary latch position, the switch pressing portion 21g presses the latch detection switch 51. In this case, the latch detection switch 51 is turned on, and detects that the latch 21 is at the primary latch position, that is, detects that the front hood FP is at the fully closed position. On the other hand, when the latch 21 is at a position other than the primary latch position, the switch pressing portion 21g does not press the latch detection switch 51. In this case, the latch detection switch 51 is turned off, and detects that the latch 21 is in the secondary latch position or the engaging standby position, that is, detects that the front hood FP is not in the fully closed position.

The primary pawl 22 and the secondary pawl 23 mesh with the latch 21 to prevent the latch 21 from rotating in the release direction against the biasing force of the latch spring 21e and stop at desired positions.

When the latch 21 is disposed at the primary latch position, the primary pawl 22 meshes with a primary meshing portion 21j formed on an outer peripheral surface of the latch 21, thereby preventing the latch 21 from rotating in the release direction and maintaining the front hood FP at the fully closed position. A primary spring 22b that constantly biases the primary pawl 22 in a meshing direction is provided between the primary pawl 22 and the base plate 11.

The primary pawl 22 has a bent portion 22c that is bent in a rotation shaft direction and is disposed on a rotation trajectory of the open lever 35. When the open lever 35 rotates in a direction (clockwise direction in FIG. 4) to abut against the primary pawl 22, the bent portion 22c is pressed by the open lever 35, and rotates the primary pawl 22 in a direction to release the meshing state with the latch 21 against a biasing force of the primary spring 22b.

The primary pawl 22 includes a frunk cable connection portion 22e. The frunk cable connection portion 22e is connected with the frunk cable 32 which links with an in-frunk handle 31 provided in the frunk FT. The in-frunk handle 31 can be operated from the inside of the frunk FT when the front hood FP is in the closed state. When the in-frunk handle 31 is operated, an operation force is transmitted to the primary pawl 22 via the frunk cable 32, and the primary pawl 22 is rotated in the direction to release the meshing state with the latch 21 against the biasing force of the primary spring 22b.

When the latch 21 is disposed at the secondary latch position, the secondary pawl 23 meshes with a secondary meshing portion 21k formed on the outer peripheral surface of the latch 21, thereby preventing the latch 21 from rotating in the release direction and maintaining the front hood FP at the half-engaged position. A secondary spring 23b that constantly biases the secondary pawl 23 in the meshing direction is provided between the secondary pawl 23 and the base plate 11.

The secondary pawl 23 has a bent portion 23c that is bent in the rotation shaft direction and is disposed on the rotation trajectory of the open lever 35. When the open lever 35 rotates in a direction (counterclockwise direction in FIG. 4) to abut against the secondary pawl 23, the bent portion 23c is pressed by the open lever 35, and rotates the secondary pawl 23 in a direction to release the meshing state with the latch 21 against a biasing force of the secondary spring 23b.

The secondary pawl 23 is provided with a vehicle cabin cable connection portion 23e. The vehicle cabin cable connection portion 23e is connected with the emergency cable 34 which links with an emergency handle 33 provided in a vehicle cabin. The emergency handle 33 is an operation portion provided in the vehicle cabin at a position where the operation is disabled while the vehicle is traveling, for example, on a back side of a foot of a driver seat. When the emergency handle 33 is operated, an operation force is transmitted to the secondary pawl 23 via the emergency cable 34, and the secondary pawl 23 is rotated in the direction to release the meshing state with the latch 21 against the biasing force of the secondary spring 23b.

The primary pawl 22 and the secondary pawl 23 are coupled via a link bar 26. The link bar 26 is provided on a side opposite to the latch 21 with respect to the primary pawl 22 and the secondary pawl 23. One end portion of the link bar 26 is rotatably pivoted by a coupling portion 23d of the secondary pawl 23, and the other end portion of the link bar 26 is rotatably pivoted by a coupling portion 22d of the primary pawl 22 via a long hole 26a.

When the secondary pawl 23 rotates in the direction to release the meshing state with the latch 21, the link bar 26 interlocks the primary pawl 22 in the direction to release the meshing state with the latch 21. On the other hand, when the primary pawl 22 rotates in the direction to release the meshing state with the latch 21, the link bar 26 causes the secondary pawl 23 to maintain the meshing state with the latch 21. In more detail, when the primary pawl 22 rotates in the direction to release the meshing state with the latch 21, the link bar 26 does not interlock the secondary pawl 23 with the movement of the coupling portion 22d along the long hole 26a. In this case, the primary pawl 22 rotates independently of the secondary pawl 23, and the secondary pawl 23 is maintained in the meshing state with the latch 21.

The open lever 35 is configured to rotate in two directions (clockwise direction and counterclockwise direction in FIG. 4) around a rotation shaft 35c by drive of the electric motor 41. Specifically, the open lever 35 is configured to rotate in a direction to engage with the primary pawl 22 by rotation of the electric motor 41 in the first direction, and is configured to rotate in a direction to engage with the secondary pawl 23 by rotation of the electric motor 41 in a second direction opposite to the first direction. In this way, since the primary pawl 22 and the secondary pawl 23 can be rotated by the single open lever 35, a space efficiency in the latch device 1 is improved, and a structure can be simplified.

The open lever 35 is provided closer to the actuator unit 40 side than the primary pawl 22 and the secondary pawl 23 in the rotation shaft direction, and is disposed at a position overlapping rotation trajectories of the primary pawl 22 and the secondary pawl 23 as viewed from the rotation shaft direction. According to such an arrangement relationship, it is possible to reduce a dimension of the latch device 1 in a direction orthogonal to the rotation shaft direction, specifically, in the up-down direction, and to achieve the compact latch device 1.

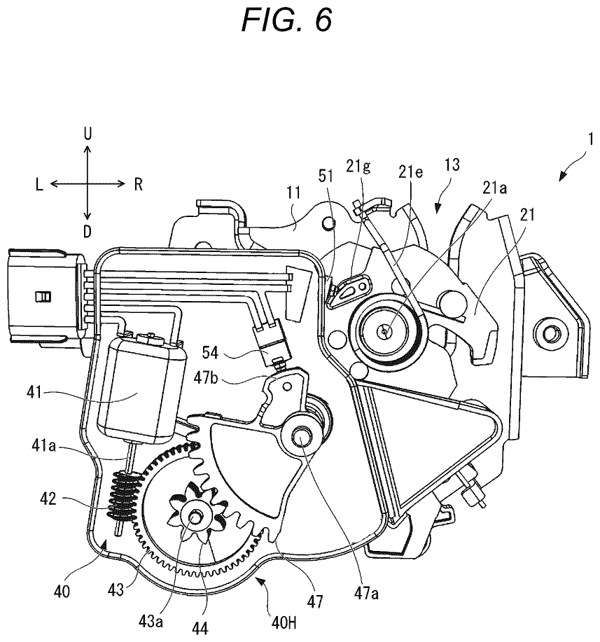

Here, a power transmission system from the electric motor 41 to the open lever 35 will be described with reference to FIG. 6. The actuator unit 40 accommodated in the actuator housing 40H includes the electric motor 41 capable of rotating forward and backward, and a speed reduction mechanism that reduces a speed of the drive of the electric motor 41 and transmits the drive to the open lever 35. The speed reduction mechanism includes a worm gear 42 provided on an output shaft 41a of the electric motor 41, a first gear (worm wheel) 43 that meshes with the worm gear 42, a second gear 44 that is provided integrally with the first gear 43, and a sector gear 47 that meshes with the second gear 44. The first gear 43 is rotatably supported by the actuator housing 40H via an individual support shaft 43a parallel to the latch shaft 21a. The sector gear 47 is rotatably supported by the actuator housing 40H via a cylindrical boss portion 47a. The boss portion (output portion) 47a of the sector gear 47 extends toward the base plate 11, and the open lever 35 is fixed to a tip of the boss portion 47a. Since the open lever 35 is fixed to the boss portion 47a, the sector gear 47 and the open lever 35 rotate together. The above-described speed reduction mechanism constitutes a power transmission unit that transmits power of the electric motor 41 to the open lever 35.

The actuator unit 40 and the actuator housing 40H are disposed at positions that do not overlap the latch shaft 21a as viewed from the rotation shaft direction of the latch 21. According to such a configuration, a sufficient space in the rotation shaft direction of the latch 21 can be ensured, and the latch spring 21e having a large biasing force can be provided in the space. Therefore, in order to increase the biasing force applied to the latch 21 to lift the front hood FP to the pop-up position, a plurality of latch springs may not be provided.

The actuator housing 40H is provided with an open lever detection switch 54 that detects the rotation position of the open lever 35 rotating integrally with the sector gear 47. The open lever detection switch 54 is pressed by a switch pressing portion 47b provided in the vicinity of the boss portion 47a of the sector gear 47, and is turned on or off in conjunction with the rotation of the sector gear 47.

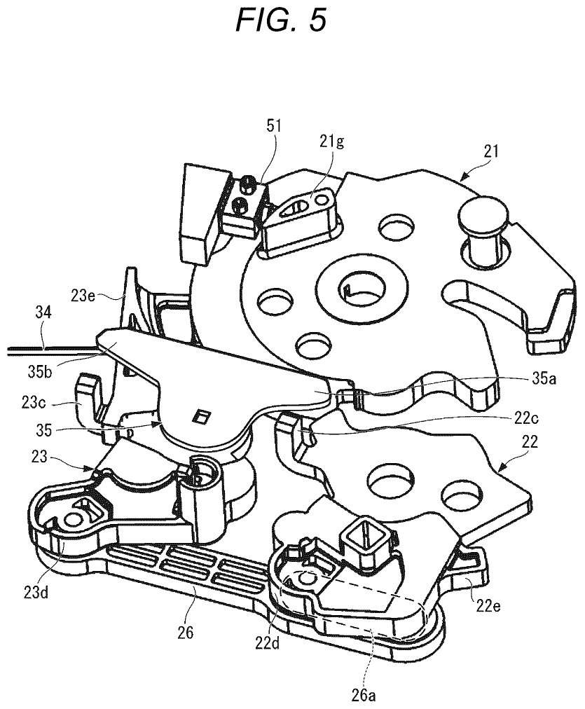

Returning to FIGS. 4 and 5, the open lever 35 includes a first pressing lever portion 35a and a second pressing lever portion 35b. The open lever 35 is disposed such that the rotation shaft 35c is positioned between the bent portion 22c of the primary pawl 22 and the bent portion 23c of the secondary pawl 23, the first pressing lever portion 35a extends from the rotation shaft 35c toward the upper portion of the bent portion 22c, and the second pressing lever portion 35b extends from the rotation shaft 35c toward the upper portion of the bent portion 23c. At a neutral position of the open lever 35, neither the first pressing lever portion 35a nor the second pressing lever portion 35b abuts against the bent portion 22c or 23c.

The bent portion 22c of the primary pawl 22 is positioned on a rotation trajectory of the first pressing lever portion 35a, and when the electric motor 41 rotates in the predetermined first direction from the neutral position, the open lever 35 rotates in the direction (clockwise direction in FIG. 4) to abut against the bent portion 22c of the primary pawl 22, and rotates the primary pawl 22 in the direction to release the meshing state with the latch 21 via the bent portion 22c. On the other hand, the bent portion 23c of the secondary pawl 23 is positioned on a rotation trajectory of the second pressing lever portion 35b, and when the electric motor 41 rotates in the second direction from the neutral position, the open lever 35 rotates in the direction (counterclockwise direction in FIG. 4) to abut against the bent portion 23c of the secondary pawl 23, and rotates the secondary pawl 23 in the direction to release the meshing state with the latch 21 via the bent portion 23c.

In this way, by forming the bent portions 22c and 23c on the primary pawl 22 and the secondary pawl 23, the primary pawl 22 and the open lever 35 are abutted against each other, and the secondary pawl 23 and the open lever 35 are abutted against each other. That is, the open lever 35 can have a simple shape, and the shape thereof can be prevented from becoming complicated.

The rotation shaft 35c of the open lever 35 is positioned substantially coaxially with the secondary shaft 23a serving as the rotation shaft of the secondary pawl 23. In more detail, the boss portion 47a of the sector gear 47 is positioned substantially coaxially with the secondary shaft 23a, and the open lever 35 is fixed to the tip of the boss portion 47a such that the rotation shaft 35c is substantially coaxial with the secondary shaft 23a. According to such a configuration, shaft torque input to the secondary pawl 23 can be equal to shaft torque output from the open lever 35 regardless of an abutting position between the open lever 35 and the secondary pawl 23. Therefore, a transmission loss of an output of the electric motor 41 to the secondary pawl 23 can be reduced. Since the abutting position between the open lever 35 and the secondary pawl 23 does not change during the rotation, an operating force of the open lever 35 is transmitted to the secondary pawl 23 without any change, and a stable operation is enabled.

(a) to (d) of FIG. 7 are diagrams showing an operation of the latch device 1 when the electric motor 41 is rotated in the second direction from a state where the front hood FP is at the fully closed position. In FIG. 7, the vehicle cabin cable connection portion 23e of the secondary pawl 23 is not shown.

As shown in (a) and (b) of FIG. 7, when the electric motor 41 drives and rotates in the second direction from a state where the latch 21 is at the primary latch position, the open lever 35 rotates in the direction to abut against the bent portion 23c of the secondary pawl 23, and the secondary pawl 23 rotates in the direction to release the meshing state with the latch 21. The rotation of the secondary pawl 23 is transmitted to the primary pawl 22 via the link bar 26, and the primary pawl 22 rotates until the meshing state with the primary meshing portion 21j of the latch 21 is released. As a result, as shown in (c) of FIG. 7, the meshing state between the latch 21 and the secondary pawl 23 and the meshing state between the latch 21 and the primary pawl 22 are released. Then, the latch 21 rotates to the engaging standby position by the biasing force of the latch spring 21e, the engagement between the striker S and the latch 21 is released, and the front hood FP is lifted to the pop-up position, and thus the front hood FP can be moved to the fully open position. After the front hood FP reaches the pop-up position, as shown in (d) of FIG. 7, the open lever 35 returns to the neutral position by the drive of the electric motor 41.

(a) to (d) of FIG. 7 illustrate the operation of the latch device 1 by the drive of the electric motor 41, and the same applies to the operation of the latch device 1 by a manual operation on the emergency handle 33 provided in the vehicle cabin. Specifically, the operation force of the emergency handle 33 is transmitted to the vehicle cabin cable connection portion 23e via the emergency cable 34, and the secondary pawl 23 rotates in the direction to release the meshing state with the latch 21. According to such a configuration, even in an emergency where the electric motor 41 does not perform the drive due to, for example, battery exhaustion, the front hood FP can be moved from the fully closed position to the fully open position by the manual operation on the emergency handle 33. Since the emergency cable 34 is directly coupled to the secondary pawl 23, an increase in the number of components can be prevented.

(a) to (d) of FIG. 8 are diagrams showing the operation of the latch device 1 when the electric motor 41 rotates in the first direction from a state where the front hood FP is at the fully closed position.

As shown in (a) and (b) of FIG. 8, when the electric motor 41 drives and rotates in the first direction from the state where the latch 21 is at the primary latch position, the open lever 35 rotates in the direction to abut against the bent portion 22c of the primary pawl 22, and the primary pawl 22 rotates in the direction to release the meshing state with the latch 21. In this case, the coupling portion 22d of the primary pawl 22 moves along the long hole 26a of the link bar 26, so that the primary pawl 22 rotates independently of the secondary pawl 23, and thus the secondary pawl 23 maintains the meshing state with the latch 21 without interlocking with the rotation of the primary pawl 22. When the primary pawl 22 rotates until the meshing state with the primary meshing portion 21j of the latch 21 is released, as shown in (c) of FIG. 8, the latch 21 rotates in the release direction by the biasing force of the latch spring 21e, and rotates to the secondary latch position where the secondary meshing portion 21k of the latch 21 and the secondary pawl 23 mesh with each other. When the latch 21 reaches the secondary latch position, the front hood FP is at the half-engaged position. After the front hood FP reaches the half-engaged position, as shown in (d) of FIG. 8, the open lever 35 returns to the neutral position by the drive of the electric motor 41.

(a) to (d) of FIG. 8 illustrate the operation of the latch device 1 according to the drive of the electric motor 41, and the same applies to the operation of the latch device 1 by a manual operation on the in-frunk handle 31 provided in the frunk. Specifically, the operation force of the in-frunk handle 31 is transmitted to the frunk cable connection portion 22e via the frunk cable 32, and the primary pawl 22 rotates in the direction to release the meshing state with the latch 21. According to such a configuration, for example, even in an emergency where a person is trapped in the frunk FT and the electric motor 41 does not perform the drive due to battery exhaustion or the like, the trapped person can manually operate the in-frunk handle 31 to set the front hood FP to the half-engaged position, and the outside can be notified of such an abnormal situation. Since the front hood FP does not move to the pop-up position in the operation of the in-frunk handle 31, the front hood FP can be prevented from reaching the fully open position during the traveling, and the safety can be ensured.

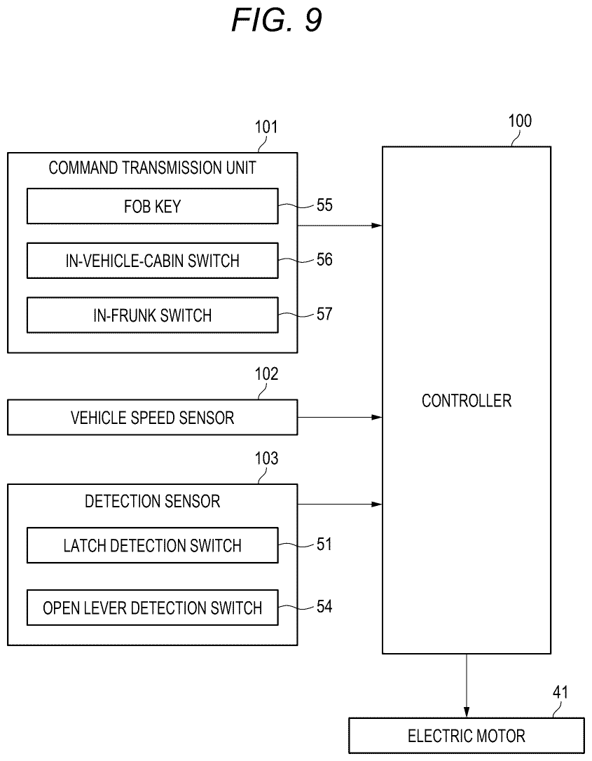

Next, a control system of the latch device 1 will be described with reference to FIG. 9. A processing device such as a central processing unit (CPU) or hardware such as an integrated circuit (IC) is mounted to constitute a controller 100. The controller 100 may be directly mounted on the housing member 10 or may be provided at a position away from the housing member 10.

When an output signal is supplied from a command transmission unit 101, a vehicle speed sensor 102, a detection sensor 103, or the like, the controller 100 controls the drive of the electric motor 41 in accordance with programs and data stored in a memory. The controller 100 may be implemented, for example, by causing a processing device such as a CPU to execute a program, that is, implemented by software, by hardware such as an IC, or by a combination of software and hardware.

The command transmission unit 101 outputs an open command to the controller 100 when the frunk FT is opened. The command transmission unit 101 includes, for example, a frequency operated button (FOB) key 55 possessed by an owner of the vehicle, an in-vehicle-cabin switch 56 provided in the vehicle cabin, and an in-frunk switch 57 provided in the frunk FT. The in-vehicle-cabin switch 56 includes, for example, a button provided in the vehicle cabin and an icon displayed on a touch panel. The in-frunk switch 57 is, for example, a button provided in the frunk FT. The vehicle speed sensor 102 detects a speed of the vehicle and outputs a detection result to the controller 100. The detection sensor 103 includes the above-described latch detection switch 51 and the open lever detection switch 54.

The controller 100 determines the control of the electric motor 41 corresponding to the open command output from the command transmission unit 101 based on the state of the vehicle. Specifically, the controller 100 determines whether to rotate the electric motor 41 in the first direction, rotate the electric motor 41 in the second direction, or prohibit the rotation of the electric motor 41 based on the state of the vehicle.

Here, the state of the vehicle includes a first state mainly including a stopped state where the vehicle is stopped and a second state mainly including a traveling state where the vehicle travels. The first state may include a stopped state where the vehicle is completely stopped, a traveling state at a low speed (for example, traveling at 5 km/h or lower), and a state where a P (parking) range is selected. The second state may include a traveling state where the vehicle is traveling at a predetermined speed or higher (for example, 5 km/h or higher), and a state where a shift range other than the P range is selected.

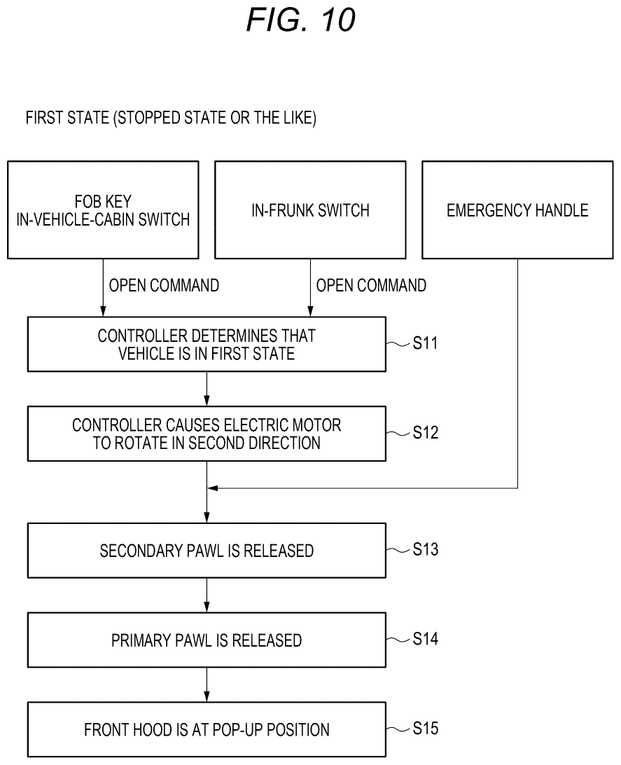

FIG. 10 is a flow of the open operation of the front hood FP when the vehicle is in the first state (stopped state or the like).

When an open command is output from the FOB key 55, the in-vehicle-cabin switch 56, or the in-frunk switch 57, the controller 100 determines the state of the vehicle, and determines that the vehicle is in the first state (step S11).

When the vehicle is in the first state, the safety is ensured even when the front hood FP is in the fully open position, and the controller 100 drives the electric motor 41 to rotate in the second direction (step S12). When the open lever 35 rotates due to the drive of the electric motor 41, the meshing state between the latch 21 and the secondary pawl 23 is released (step S13), and the meshing state between the latch 21 and the primary pawl 22 is also released via the link bar 26 (step S14). Accordingly, the front hood FP is at the pop-up position from the fully closed position (step S15), and is movable to the fully open position.

When the emergency handle 33 is operated when the vehicle is in the first state, the process proceeds to steps S13 to S15 without the drive of the electric motor 41, and the front hood FP is at the pop-up position from the fully closed position.

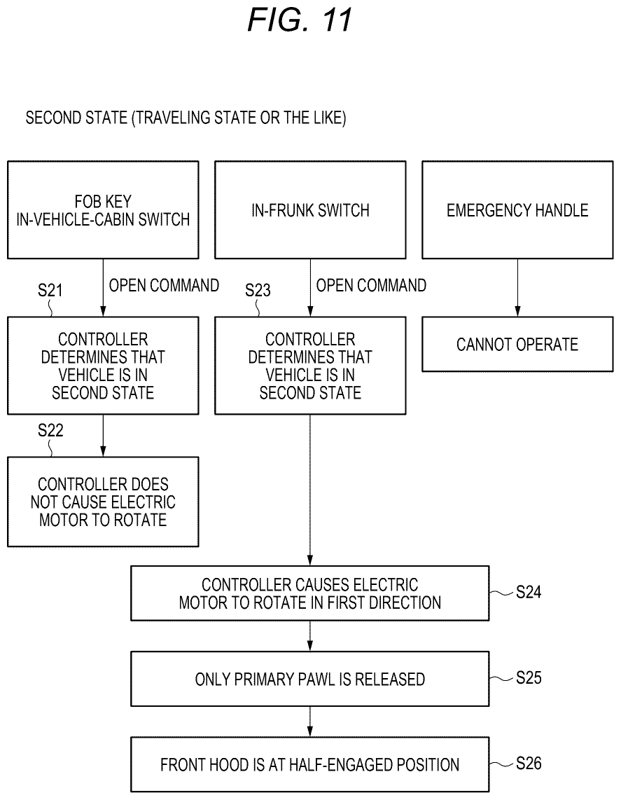

FIG. 11 is a flow of the open operation of the front hood FP when the vehicle is in the second state (traveling state or the like).

When the open command is output from the FOB key 55 or the in-vehicle-cabin switch 56, the controller 100 determines the state of the vehicle, and determines that the vehicle is in the second state (step S21). Then, the controller 100 does not cause the electric motor 41 to rotate in response to the open command from the FOB key 55 or the in-vehicle-cabin switch 56 (step S22). That is, the safety can be ensured without opening the front hood FP during the traveling. The FOB key 55 and the in-vehicle-cabin switch 56 may be configured such that the open command cannot be output to the controller 100 when the vehicle is in the second state.

When the open command is output from the in-frunk switch 57, the controller 100 determines the state of the vehicle, and determines that the vehicle is in the second state (step S23). Then, the controller 100 causes the electric motor 41 to rotate in the first direction in response to the open command from the in-frunk switch 57 (step S24). The open lever 35 rotates due to the drive of the electric motor 41, so that only the meshing state between the latch 21 and the primary pawl 22 is released (step S25). Accordingly, the front hood FP is at the half-engaged position from the fully closed position (step S26).

For example, in a case where a person is trapped in the frunk FT, if the open command is input to the in-frunk switch 57, even if the vehicle is in the second state, the front hood FP is at the half-engaged position, and thus the outside can be notified of an abnormal state. Since the front hood FP is not at the fully open position, the safety during the traveling can be ensured.

As described above, the emergency handle 33 is an operation portion that is provided in the vehicle cabin at a position where the operation is disabled while the vehicle is traveling, and thus when the vehicle is in the second state, the emergency handle 33 cannot be operated. Accordingly, the front hood FP is not at the fully open position, and the safety during the traveling can be ensured.

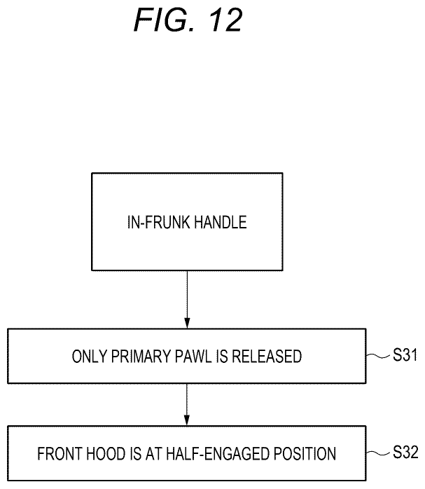

FIG. 12 is a flow of the open operation of the front hood FP by the in-frunk handle 31. The operation by the in-frunk handle 31 is based on the flow of FIG. 12 regardless of the state of the vehicle.

When the in-frunk handle 31 is operated, the operation force is transmitted to the primary pawl 22 via the frunk cable 32, and only the meshing state between the latch 21 and the primary pawl 22 is released (step S31). Accordingly, the front hood FP is at the half-engaged position from the fully closed position (step S32).

For example, when a person is trapped in the frunk FT, if the frunk cable 32 is operated, the front hood FP is at the half-engaged position, and thus the outside can be notified of the abnormal state, and since the front hood FP is not at the fully open position, the safety can be further ensured during the traveling.

As described above, the open lever 35 can release only the meshing state between the latch 21 and the primary pawl 22 or release both the meshing state between the latch 21 and the primary pawl 22 and the meshing state between the latch 21 and the secondary pawl 23 according to the rotation direction of the electric motor 41, and thus according to the latch device 1 of the present embodiment, it is possible to change opening control on the front hood FP depending on the state of the vehicle (above-described traveling state or stopped state).

For example, even when an open command for opening the front hood FP is issued while the vehicle is traveling, if the rotation of the electric motor 41 is restricted only in the first direction, the front hood FP can be prevented from being unintentionally brought into the fully open position during the traveling, and the safety can be ensured. For example, in a case where there is no problem even when the front hood FP is at the fully open position, such as when the vehicle is stopped, by causing the electric motor 41 to rotate in the second direction, both the meshing state between the latch 21 and the primary pawl 22 and the meshing state between the latch 21 and the secondary pawl 23 can be released simultaneously. That is, the front hood FP can be moved from the fully closed position to the fully open position by a fewer operation of causing the electric motor 41 to rotate in the second direction. Therefore, it is possible to improve convenience while ensuring the safety when the front hood FP is opened.

Although an embodiment of the present disclosure has been described above with reference to the accompanying drawings, it is needless to say that the present disclosure is not limited to the embodiment. It is apparent to those skilled in the art that various modifications or corrections can be conceived within the scope described in the claims, and it is understood that the modifications or corrections naturally fall within the technical scope of the present disclosure. Components in the above embodiments may be freely combined without departing from the gist of the disclosure.

The present specification describes at least the following matters. Corresponding components and the like in the above-described embodiments are described in parentheses as an example, and the present disclosure is not limited thereto.

(1) A latch device (latch device 1) for a front hood of a vehicle, the latch device being provided to be engageable with a striker (striker S) provided at the front hood (front hood FP) and performing opening and closing control of the front hood, the latch device including:
a latch (latch 21) configured to engage with the striker when the front hood is in a closed state, the latch being biased by a biasing member (latch spring 21e) in a direction to disengage from the striker;
a primary pawl (primary pawl 22) configured to mesh with the latch when the latch engaging with the striker is disposed at a predetermined primary latch position to maintain the front hood at a fully closed position;
a secondary pawl (secondary pawl 23) configured to mesh with the latch when the latch released from a meshing state with the primary pawl is disposed at a predetermined secondary latch position to maintain the front hood at a half-engaged position;
a motor (electric motor 41) configured to rotate forward and backward; and
a release mechanism (open lever 35) configured to operate by drive of the motor and release the meshing state between the latch and the primary pawl and a meshing state between the latch and the secondary pawl, in which
the release mechanism is configured to
release the meshing state between the latch and the primary pawl by rotation of the motor in a first direction to move the front hood from the fully closed position to the half-engaged position, and
release the meshing state between the latch and the primary pawl and the meshing state between the latch and the secondary pawl by rotation of the motor in a second direction opposite to the first direction to allow the front hood to move from the fully closed position to a fully open position.

According to (1), the release mechanism can release the meshing state between the latch and the primary pawl or release both the meshing state between the latch and the primary pawl and the meshing state between the latch and the secondary pawl according to the rotation direction of the motor, and thus it is possible to change an opening control on the front hood depending on the state of the vehicle (traveling state or stopped state). Accordingly, for example, even when a command to open the front hood is issued while the vehicle is traveling, it can be prevented that the front hood is unintentionally brought into the fully open position during the traveling only by restricting the motor to rotate in the first direction, and the safety can be ensured. For example, in a case where there is no problem even when the front hood is at the fully open position, such as when the vehicle is stopped, by causing the motor to rotate in the second direction opposite to the first direction, both the meshing state between the latch and the primary pawl and the meshing state between the latch and the secondary pawl can be released simultaneously. That is, the front hood can be moved from the fully closed position to the fully open position by a fewer operation of rotating the electric motor in the second direction. Therefore, it is possible to improve convenience while ensuring the safety when the front hood is opened.

(2) The latch device for a front hood according to (1), further including:
a link member (link bar 26) configured to couple the primary pawl and the secondary pawl, in which
the link member is provided to coordinate the primary pawl and the secondary pawl such that the secondary pawl maintains the meshing state with the latch when the primary pawl operates in a direction to release the meshing state with the latch, and the primary pawl operates in the direction to release the meshing state with the latch when the secondary pawl operates in a direction to release the meshing state with the latch.

According to (2), the link member makes it possible to rotate the motor in the first direction to release the meshing state between the latch and the primary pawl, and to rotate the motor in the second direction to release both the meshing state between the latch and the primary pawl and the meshing state between the latch and the secondary pawl simultaneously.

(3) The latch device for a front hood according to (2), in which
the release mechanism includes a lever (open lever 35) configured to rotate in a direction to engage with the primary pawl by the rotation of the motor in the first direction, and rotate in a direction to engage with the secondary pawl by the rotation of the motor in the second direction, and
the lever is configured to
rotate the primary pawl independently of the secondary pawl by the rotation of the motor in the first direction, releasing the meshing state between the latch and the primary pawl, and maintaining the meshing state between the secondary pawl and the latch, and
rotate the secondary pawl and the primary pawl that is linked with the rotation of the secondary pawl by the rotation of the motor in the second direction, releasing the meshing state between the latch and the primary pawl and the meshing state between the latch and the secondary pawl.

According to (3), since each pawl can be rotated by a single lever, a space efficiency in the latch device is improved, and a structure can be simplified.

(4) The latch device for a front hood according to (3), in which
the lever is disposed at a position overlapping rotation trajectories of the primary pawl and the secondary pawl as viewed from a rotation shaft direction of the lever, and each of the primary pawl and the secondary pawl has a bent portion (bent portion 22c, 23c) bent in the rotation shaft direction and disposed on a rotation trajectory of the lever.

According to (4), the lever is disposed at the position overlapping the rotation trajectory of each pawl as viewed from the rotation shaft direction, and thus a dimension in a direction perpendicular to the rotation shaft direction is reduced, and a size can be reduced. By implementing abutting between each pawl and the lever by the bent portion formed in each pawl, a shape of the lever can be prevented from becoming complicated.

(5) The latch device for a front hood according to (3) or (4), in which
the lever is disposed at a position overlapping rotation trajectories of the primary pawl and the secondary pawl as viewed from a rotation shaft direction of the lever, and a rotation shaft (rotation shaft 35c) of the lever and a rotation shaft (secondary shaft 23a) of the secondary pawl are positioned substantially coaxially.

According to (5), the lever is disposed at the position overlapping the rotation trajectory of each pawl as viewed from the rotation shaft direction, and thus a dimension in a direction perpendicular to the rotation shaft direction is reduced, and a size can be reduced. Further, since the rotation shaft of the lever and the rotation shaft of the secondary pawl are positioned substantially coaxially, shaft torque input to the secondary pawl can be made equal to shaft torque output from the lever regardless of an abutting position between the lever and the secondary pawl. Accordingly, a transmission loss of a motor output to the secondary pawl can be reduced. Since the rotation shaft of the lever and the rotation shaft of the secondary pawl are positioned substantially coaxially, the abutting position between the lever and the secondary pawl does not change during the rotation. Accordingly, an operating force of the lever is transmitted without any change to the secondary pawl during the rotation, and a stable operation is enabled.

(6) The latch device for a front hood according to any one of (3) to (5), in which
an actuator unit (actuator unit 40) including the motor and a power transmission unit that transmits power of the motor to the lever is disposed at a position that does not overlap a rotation shaft (latch shaft 21a) of the latch as viewed from a rotation shaft direction of the latch.

According to (6), a sufficient space in the rotation shaft direction of the latch can be ensured, and the biasing member having a large biasing force can be provided in the space.

(7) The latch device for a front hood according to any one of (2) to (6), in which
the secondary pawl is coupled to a first operation transmission unit (emergency cable 34) that transmits an operation force manually input to a first operation portion (emergency handle 33) provided in a vehicle cabin.

According to (7), even in an emergency where the motor does not perform the drive due to, for example, battery exhaustion, the secondary pawl is operated by manually operating the first operation portion of the vehicle cabin, and the meshing state between the latch and the primary pawl and the meshing state between the latch and the secondary pawl are released to enable the front hood to move from the fully closed position to the fully open position. Since the first operation transmission unit is directly coupled to the secondary pawl, an increase in the number of components can be prevented.

(8) The latch device for a front hood according to any one of (2) to (7), in which
the primary pawl is coupled to a second operation transmission unit (frunk cable 32) that transmits an operation force manually input by a second operation portion (in-frunk handle 31) provided in a front trunk (frunk FT) covered by the front hood.

According to (8), the primary pawl can be operated by manually operating the second operation portion in the front trunk, the meshing state between the latch and the primary pawl can be released to place the front hood at the half-engaged position from the fully closed position. Accordingly, even in an emergency where a person is trapped in the front trunk and the motor does not perform the drive due to battery exhaustion or the like, the outside can be notified of this abnormal situation. Even when the second operation portion is operated, the front hood stays at the half-engaged position, and thus the front hood can be prevented from reaching the fully open position during the traveling, and the safety can be ensured.

(9) The latch device for a front hood according to any one of (1) to (8), further including:
a controller (controller 100) configured to control rotation and drive of the motor, in which
the controller causes the motor to rotate in the first direction on determining that an input is made to an electric operation portion (in-frunk switch 57) provided in a front trunk (frunk FT) covered by the front hood and the vehicle is in a predetermined state (second state), and
the predetermined state includes at least one of a state where the vehicle is traveling at a predetermined speed or higher or a state where a shift range other than a parking range is selected.

According to (9), when the vehicle is traveling or in a travelable state, the motor rotates in the first direction in response to the input to the electric operation portion inside the front trunk to place the front hood at the half-engaged position, and thus the front hood can be prevented from being in the fully open position and the safety can be ensured while the outside is notified of an abnormal situation in which a person is trapped inside the front trunk.

What is claimed is:

1. A latch device for a front hood of a vehicle, the latch device being provided to be engageable with a striker provided at the front hood and performing opening and closing control of the front hood, the latch device comprising:
a latch configured to engage with the striker when the front hood is in a closed state, the latch being biased by a biasing member in a direction to disengage from the striker;
a primary pawl configured to mesh with the latch when the latch engaging with the striker is disposed at a predetermined primary latch position to maintain the front hood at a fully closed position;
a secondary pawl configured to mesh with the latch when the latch released from a meshing state with the primary pawl is disposed at a predetermined secondary latch position to maintain the front hood at a half-engaged position;
a motor configured to rotate forward and backward; and
a release mechanism configured to operate by drive of the motor and release the meshing state between the latch and the primary pawl and a meshing state between the latch and the secondary pawl, wherein
the release mechanism is configured to
release the meshing state between the latch and the primary pawl by rotation of the motor in a first direction to move the front hood from the fully closed position to the half-engaged position, and
release the meshing state between the latch and the primary pawl and the meshing state between the latch and the secondary pawl by rotation of the motor in a second direction opposite to the first direction to allow the front hood to move from the fully closed position to a fully open position.

2. The latch device for a front hood according to claim 1, further comprising:
a link member configured to couple the primary pawl and the secondary pawl, wherein
the link member is provided to coordinate the primary pawl and the secondary pawl such that the secondary pawl maintains the meshing state with the latch when the primary pawl operates in a direction to release the meshing state with the latch, and the primary pawl operates in the direction to release the meshing state with the latch when the secondary pawl operates in a direction to release the meshing state with the latch.

3. The latch device for a front hood according to claim 2, wherein
the release mechanism includes a lever configured to rotate in a direction to engage with the primary pawl by the rotation of the motor in the first direction, and rotate in a direction to engage with the secondary pawl by the rotation of the motor in the second direction, and
the lever is configured to
rotate the primary pawl independently of the secondary pawl by the rotation of the motor in the first direction, releasing the meshing state between the latch and the primary pawl, and maintaining the meshing state between the secondary pawl and the latch, and
rotate the secondary pawl and the primary pawl that is linked with the rotation of the secondary pawl by the rotation of the motor in the second direction, releasing the meshing state between the latch and the primary pawl and the meshing state between the latch and the secondary pawl.

4. The latch device for a front hood according to claim 3, wherein
the lever is disposed at a position overlapping rotation trajectories of the primary pawl and the secondary pawl as viewed from a rotation shaft direction of the lever, and
each of the primary pawl and the secondary pawl has a bent portion bent in the rotation shaft direction and disposed on a rotation trajectory of the lever.

5. The latch device for a front hood according to claim 3, wherein
the lever is disposed at a position overlapping rotation trajectories of the primary pawl and the secondary pawl as viewed from a rotation shaft direction of the lever, and
a rotation shaft of the lever and a rotation shaft of the secondary pawl are positioned substantially coaxially.

6. The latch device for a front hood according to claim 3, wherein
an actuator unit including the motor and a power transmission unit that transmits power of the motor to the lever is disposed at a position that does not overlap a rotation shaft of the latch as viewed from a rotation shaft direction of the latch.

7. The latch device for a front hood according to claim 2, wherein
the secondary pawl is coupled to a first operation transmission unit that transmits an operation force manually input to a first operation portion provided in a vehicle cabin.

8. The latch device for a front hood according to claim 2, wherein
the primary pawl is coupled to a second operation transmission unit that transmits an operation force manually input by a second operation portion provided in a front trunk covered by the front hood.

9. The latch device for a front hood according to claim 1, further comprising:
a controller configured to control rotation and drive of the motor, wherein
the controller causes the motor to rotate in the first direction on determining that an input is made to an electric operation portion provided in a front trunk covered by the front hood and the vehicle is in a predetermined state, and
the predetermined state includes at least one of a state where the vehicle is traveling at a predetermined speed or higher or a state where a shift range other than a parking range is selected.
